(19) United States
(12) Patent Application Publication
(10) Pub. No.: US 2025/0285443 A1
(43) Pub. Date: Sep. 11, 2025

(54) MONITORING DEVICE, MONITORING METHOD, AND COMPUTER PROGRAM FOR MONITORING

(71) Applicants: TOYOTA JIDOSHA KABUSHIKI KAISHA, Toyota-shi Aichi-ken (JP); AISIN CORPORATION, Kariya Aichi (JP)

(72) Inventors: Hiroshi Yokoyama, Koto-ku Tokyo-to (JP); Takuya Hashikawa, Minato-ku Tokyo-to (JP)

(73) Assignees: TOYOTA JIDOSHA KABUSHIKI KAISHA, Toyota-shi Aichi-ken (JP); AISIN CORPORATION, Kariya Aichi (JP)

(21) Appl. No.: 19/063,796

(22) Filed: Feb. 26, 2025

(30) Foreign Application Priority Data
Mar. 6, 2024 (JP) 2024-034279

(51) Int. Cl. G06V 20/52; G06T 7/70; G06V 40/10

(52) U.S. Cl. CPC G06V 20/52; G06T 7/70; G06V 40/10; G06T 2207/10016; G06T 2207/30196; G06T 2207/30232

(57) ABSTRACT

A monitoring device includes a processor configured to detect a person from each of a plurality of time-series images generated by a camera, track the detected person in one or more images representing the person among the plurality of images, determine whether the position of the detected person in the images has been within a first area in the images corresponding to an exclusion zone for a first period and whether the position of the detected person in the images has been within a second area in the images adjacent to the first area for a second period longer than the first period, based on the tracking result, and determine that the detected person has entered the exclusion zone, when the position of the detected person in the images has been within the first area for the first period or within the second area for the second period.

### CROSS-REFERENCE TO RELATED APPLICATIONS

This application claims priority to Japanese Patent Application No. 2024-034279 filed Mar. 6, 2024, the entire contents of which are herein incorporated by reference.

### FIELD

The present disclosure relates to a monitoring device, a monitoring method, and a computer program for monitoring a predetermined region with images representing the predetermined region.

### BACKGROUND

A technique for monitoring the state of a predetermined region with images representing the region has been proposed (see Japanese Unexamined Patent Publication JP2023-3974A). A vehicle interior-monitoring system disclosed in JP2023-3974A recognizes a person and baggage included in a vehicle interior image captured by an image capturing device provided on the ceiling of a shared vehicle, and estimates whether the recognized person is sitting or standing. Based on the positions of the recognized baggage and person, the vehicle interior-monitoring system estimates whether there is a seat occupied by baggage and whether there are seats occupied by a sitting person.

### SUMMARY

Some vehicles have a no-entry zone therein where entry of a passenger is undesirable. It is desirable to detect entry of a passenger into such a zone.

It is an object of the present disclosure to provide a monitoring device that can detect entry of a person into an exclusion zone.

As an aspect of the present disclosure, a monitoring device is provided. The monitoring device includes a processor configured to: detect a person from each of a plurality of time-series images generated by a camera configured to take pictures of a predetermined region including an exclusion zone, track the detected person in one or more images representing the person among the plurality of images, determine whether the position of the detected person in the images has been within a first area in the images corresponding to the exclusion zone for a first period and whether the position of the detected person in the images has been within a second area in the images adjacent to the first area for a second period longer than the first period, based on the result of tracking, and determine that the detected person has entered the exclusion zone, when the position of the detected person in the images has been within the first area for the first period or within the second area for the second period.

In an embodiment, the processor is further configured to detect at least two different parts of the person from each of the plurality of time-series images, track each of the detected at least two parts, and determine that the person has entered the exclusion zone, when the position of one of the detected at least two parts in the images has been within the first area for the first period or within the second area for the second period.

In this case, the first area and the second area are set for each of the at least two parts.

According to another embodiment, a monitoring method is provided. The monitoring method includes detecting a person from each of a plurality of time-series images generated by a camera configured to take pictures of a predetermined region including an exclusion zone; tracking the detected person in one or more images representing the person among the plurality of images; determining whether the position of the detected person in the images has been within a first area in the images corresponding to the exclusion zone for a first period and whether the position of the detected person in the images has been within a second area in the images adjacent to the first area for a second period longer than the first period, based on the result of tracking; and determining that the detected person has entered the exclusion zone, when the position of the detected person in the images has been within the first area for the first period or within the second area for the second period.

According to still another embodiment, a non-transitory recording medium that stores a computer program for monitoring is provided. The computer program includes instructions causing a computer to execute a process including detecting a person from each of a plurality of time-series images generated by a camera configured to take pictures of a predetermined region including an exclusion zone; tracking the detected person in one or more images representing the person among the plurality of images; determining whether the position of the detected person in the images has been within a first area in the images corresponding to the exclusion zone for a first period and whether the position of the detected person in the images has been within a second area in the images adjacent to the first area for a second period longer than the first period, based on the result of tracking; and determining that the detected person has entered the exclusion zone, when the position of the detected person in the images has been within the first area for the first period or within the second area for the second period.

The monitoring device according to the present disclosure has an effect of being able to detect entry of a person into an exclusion zone.

### BRIEF DESCRIPTION OF DRAWINGS

FIG. 1 schematically illustrates the configuration of a vehicle equipped with a monitoring device according to an embodiment.

FIG. 2 illustrates the interior of the vehicle.

FIG. 3 schematically illustrates the configuration of the monitoring device.

FIG. 4 is a functional block diagram of a processor related to a monitoring process.

FIG. 5A is a schematic diagram illustrating the monitoring process.

FIG. 5B is another schematic diagram illustrating the monitoring process.

FIG. 5C is still another schematic diagram illustrating the monitoring process.

FIG. 6 is an operation flowchart of the monitoring process.

### DESCRIPTION OF EMBODIMENTS

A monitoring device, a monitoring method, and a computer program for monitoring will now be described with reference to the attached drawings. The monitoring device detects a person in a predetermined region including an exclusion zone from each of a plurality of time-series images representing the predetermined region, and tracks the detected person over the images. For each person being tracked, the monitoring device determines whether the position of the person in the images is within a first area in the images corresponding to the exclusion zone and whether the position of the person in the images is within a second area in the images adjacent to the first area. The monitoring device determines that the person has entered the exclusion zone, when duration during which the position of the person in the images is within the first area reaches a first period or when duration during which the position of the person in the images is within the second area reaches a second period.

The following describes an example in which the monitoring device is applied to monitoring the interior of a vehicle that multiple passengers can get on. A passenger is an example of a person to be detected. However, the monitoring device is not limited to this example, and may be used for monitoring a no-entry zone in a moving object that passengers or crew members can get on, such as a railway vehicle, or in a building or a facility.

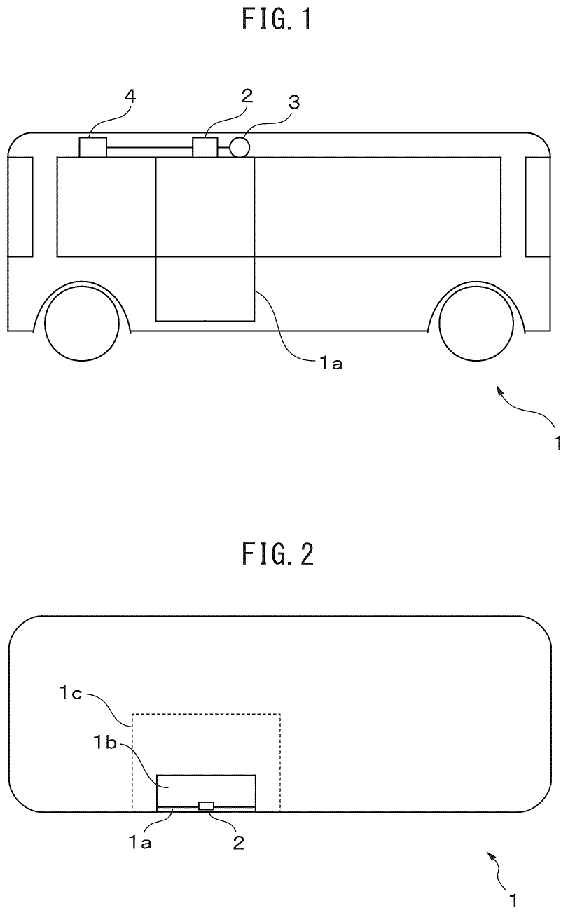

FIG. 1 schematically illustrates the configuration of a vehicle equipped with a monitoring device according to an embodiment. FIG. 2 illustrates the interior of the vehicle equipped with the monitoring device, viewed from above. The vehicle 1 equipped with the monitoring device is a vehicle with enough interior space for multiple passengers to get on and to stand and move around, such as a bus. The vehicle 1 includes a camera 2, an alert device 3, and a monitoring device 4.

In the interior of the vehicle 1, an exclusion zone 1b is set adjacent to an entrance 1a for passengers to get on or off the vehicle 1. The exclusion zone 1b is a region where entry of passengers is not allowed at opening and closing a door provided at the entrance 1a so as not to pose a danger to the passengers when the door opens and closes.

The camera 2, which is an example of the image capturing unit, is mounted, for example, near the ceiling of the vehicle interior at the entrance 1a of the vehicle 1 and oriented vertically downward so that the area captured by the camera includes a predetermined region 1c in the vehicle interior around the entrance 1a of the vehicle 1. In the present embodiment, the camera 2 is mounted so that the entrance 1a is represented on the bottom side of images generated by the camera 2. The predetermined region 1c is set as a region including the whole exclusion zone 1b and being larger than the exclusion zone 1b so that a passenger who has entered the exclusion zone 1b can be detected from an image generated by the camera 2. The camera 2 generates an image representing the predetermined region 1c around the entrance 1a every predetermined capturing period (e.g., 1/30 to 1/10 seconds). Images obtained by the camera 2 may be color or grayscale images. When the vehicle 1 has multiple entrances, each entrance may be provided with a camera 2 that can take pictures of a predetermined region around the entrance. Every time an image is generated, the camera 2 outputs the generated image to the monitoring device 4 via an in-vehicle network.

The alert device 3 can issue a predetermined alert to a passenger near the entrance 1a, includes, for example, a speaker, a buzzer, a beeper, or a display, and is mounted near the entrance 1a in the interior of the vehicle 1. According to an alert signal from the monitoring device 4, the alert device 3 outputs a voice representing a predetermined alert, e.g., an alert meaning a warning of entry of a passenger into the exclusion zone 1b, or displays a message corresponding to the alert.

The monitoring device 4 executes a monitoring process, based on images generated by the camera 2.

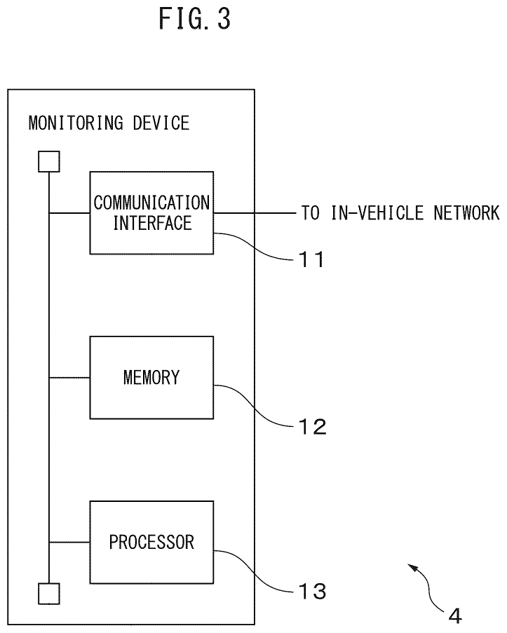

FIG. 3 illustrates the hardware configuration of the monitoring device 4. As illustrated in FIG. 3, the monitoring device 4 includes a communication interface 11, a memory 12, and a processor 13. The communication interface 11, the memory 12, and the processor 13 may be configured as separate circuits or a single integrated circuit.

The communication interface 11 includes an interface circuit for connecting the monitoring device 4 to the in-vehicle network. Every time an image is received from the camera 2, the communication interface 11 passes the received image to the processor 13. When an alert signal to be outputted to the alert device 3 is received from the processor 13, the communication interface 11 outputs the alert signal to the alert device 3.

The memory 12, which is an example of a storage unit, includes, for example, volatile and nonvolatile semiconductor memories. The memory 12 stores various algorithms and various types of data used in a monitoring process executed by the processor 13 of the monitoring device 4. For example, the memory 12 stores parameters for specifying a classifier used for detecting an occupant as well as the positions and areas of various regions in images. In addition, the memory 22 temporarily stores images received from the camera 2 and various types of data generated during the monitoring process.

The processor 13 includes one or more central processing units (CPUs) and a peripheral circuit thereof. The processor 13 may further include another operating circuit, such as a logic-arithmetic unit, an arithmetic unit, or a graphics processing unit. The processor 13 executes the monitoring process.

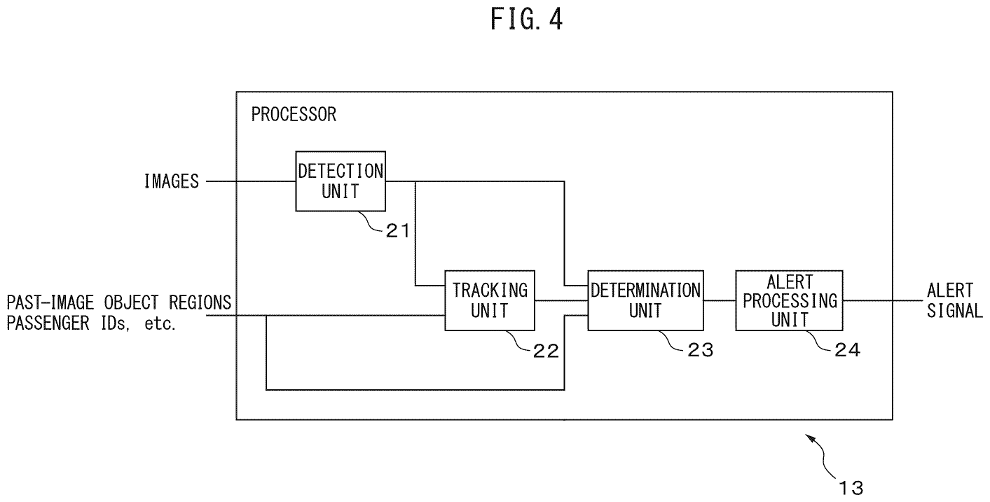

FIG. 4 is a functional block diagram of the processor 13 related to the monitoring process. The processor 13 includes a detection unit 21, a tracking unit 22, a determination unit 23, and an alert processing unit 24. These units included in the processor 13 are, for example, functional modules implemented by a computer program executed by the processor 13, or may be dedicated operating circuits provided in the processor 13.

The detection unit 21 detects a passenger in the predetermined region from each of a plurality of time-series images generated by the camera 2. In the present embodiment, the detection unit 21 detects a passenger at each predetermined period from the latest image obtained by the camera 2. The following describes a process for a single image because the detection unit 21 executes the same process for each image.

In the present embodiment, the detection unit 21 detects at least two of a passenger's attribute, carried object, and part individually from an image. Examples of a passenger's attribute, carried object, and part individually set as detection targets include “human” (i.e., the whole body of the passenger), “head,” “infant,” “wheelchair,” “baby carriage,” and “suitcase.” Attributes, carried objects, and parts to be detected are not limited to the above-mentioned examples. For example, when it is expected that only a passenger's hand or foot may be represented in an image, “hand” or “foot” may be additionally set as a part to be detected. Depending on the positional relationship between the camera 2 and the exclusion zone, some of the above-mentioned attributes, carried objects, and parts need not be detected individually. In addition, the detection unit 21 may set only a passenger himself/herself as a detection target, when the positional relationship between the passenger's position and the exclusion zone can be grasped even if attributes, carried objects, and parts to be detected are not set individually. In the following, a passenger's attribute, carried object, and part will be simply referred to as a “part” for convenience of description.

The detection unit 21 detects these parts by inputting an image received by the monitoring device 4 from the camera 2 into a classifier that has been trained to detect these parts. As such a classifier is used one based on a “deep neural network (DNN).” For example, a DNN having architecture of a convolutional neural network (CNN) type, such as Single Shot MultiBox Detector or YOLO, or a DNN having an attention mechanism, such as Vision Transformer, is used as the classifier. Alternatively, a classifier based on another machine learning technique, such as AdaBoost or a support vector machine, may be used as the classifier. The classifier is trained in advance, using a large number of training images including images representing a part to be detected, in accordance with a predetermined training technique, such as backpropagation.

The classifier outputs regions each representing a part to be detected in the inputted image (hereafter “object regions”) and confidence scores of the respective object regions. When multiple object regions respectively representing parts of the same type overlap, the detection unit 21 executes Non-Maximum Suppression (NMS) or Soft NMS to prevent a single passenger's part from being detected multiple times. More specifically, the detection unit 21 calculates an Intersection over Union (IoU) of multiple overlapping object regions representing the same part, and discards object regions other than the object region having a maximum confidence score when the IoU is not less than a predetermined threshold. Alternatively, the detection unit 21 reduces the confidence score as the IoU increases, and discards object regions whose reduced confidence scores are less than a predetermined detection threshold.

In a single image, different parts of the same passenger may be detected separately. For example, an object region representing the whole of a passenger and an object region representing the passenger's head may be detected separately in a single image. Alternatively, an object region representing the whole of a passenger and an object region representing a suitcase carried by the passenger may be detected separately in a single image.

For each passenger's part detected from the image, the detection unit 21 notifies the tracking unit 22 and the determination unit 23 of the passenger's part and the position and area of an object region representing the passenger's part.

The tracking unit 22 tracks the detected passenger in one or more images representing the passenger among the plurality of time-series images generated by the camera 2. In the present embodiment, the tracking unit 22 executes a tracking process for each detected passenger's part because each part is detected individually. More specifically, the tracking unit 22 associates object regions representing the same passenger's part, among the object regions representing individual passengers' parts, with each other over the plurality of images. In the case where detection is not executed on a part-by-part basis and where only the whole of a passenger is a detection target, the tracking unit 22 executes the following process for each detected passenger.

To achieve this, the tracking unit 22 applies a predetermined tracking technique, such as KLT tracking or ByteTrack, to each object region in the latest image. In this way, the tracking unit 22 associates, for each object region in the latest image, a passenger's part represented in the object region with an object region representing the same passenger's part that is detected in a previously obtained image (hereafter a “past image”) and that is being tracked. Every time notification of the result of detection in the latest image is given by the detection unit 21, the tracking unit 22 repeats the above-described process to track each passenger's part, and assigns a unique identification number (hereafter a “passenger ID”) to each passenger's part being tracked. The tracking unit 22 starts new tracking of an object region that is not associated with any object region representing a passenger being tracked in the past image among the object regions detected from the latest image, assuming that the passenger's part represented in the object region is of a passenger who has entered the predetermined region anew. Conversely, when an object region representing one of the passengers' parts being tracked in the past image is not associated with any object region in the latest image, the tracking unit 22 finishes tracking, assuming that the part of the passenger being tracked has exited the predetermined region.

When different parts of the same passenger are detected, each detected part may be tracked and assigned a passenger ID separately. For example, in some cases, the whole of a passenger is detected as a “human”; the same passenger's “head” is also detected; each of them is tracked; and thus the whole passenger and the head are assigned a passenger ID separately.

Based on the result of tracking by the tracking unit 22, the determination unit 23 determines whether the position of the detected passenger in the images has been within a first area in the images corresponding to the exclusion zone 1b for a first period. The determination unit 23 also determines whether the position of the detected passenger in the images has been within a second area in the images adjacent to the first area for a second period longer than the first period. Even if a passenger's part has entered the exclusion zone 1b, the part may be outside the first area in an image, depending on the height of the part from the floor of the vehicle interior. Thus the second area is set adjacent to the outer boundary of the exclusion zone 1b so that such a part in the exclusion zone 1b may be within the second area. The size of the second area is, for example, approximately 5% to 100% of the width in the vertical or horizontal direction of the first area.

The determination unit 23 determines that the passenger has entered the exclusion zone 1b, when the position of the detected passenger in the images has been within the first area for the first period or within the second area for the second period. The determination unit 23 determines that no passenger has entered the exclusion zone at the time of determination, when, for each passenger, duration during which the passenger's position in the images is within the first area does not reach the first period, and duration during which the passenger's position in the images is within the second area does not reach the second period. The determination unit 23 may determine that a passenger who has been determined to have entered the exclusion zone 1b has exited the exclusion zone 1b, when the passenger's position in the images has been outside the first and second areas for a predetermined period.

In the present embodiment, the determination unit 23 executes the above-described process for each passenger's part assigned the same passenger ID. For this reason, even if the whole body of the passenger is not within the exclusion zone 1b, the determination unit 23 can correctly determine whether the passenger has entered the exclusion zone 1b.

In the present embodiment, the camera 2 is mounted so that the entrance 1a is represented on the bottom side of images and that the camera takes pictures vertically downward from the ceiling side of the vehicle interior, as described above. For this reason, the bottom of an object region is assumed to indicate the bottom position of a passenger's part represented in the object region. More specifically, when a passenger's part represented in an object region is a “human” itself, the bottom of the object region is supposed to indicate the position of the passenger's feet. Thus, for each passenger's part, the determination unit 23 determines that the passenger's position is within the first area, when the bottom of the object region is within the first area, and determines that the passenger's position is not within the first area, when the bottom of the object region is outside the first area. Similarly, for each passenger's part, the determination unit 23 determines that the passenger's position is within the second area, when the bottom of the object region is within the second area, and determines that the passenger's position is not within the second area, when the bottom of the object region is outside the second area. To determine that the position of a passenger is within the first area, the whole of the bottom side of the object region need not be within the first area, and at least a predetermined percentage (e.g., 10% to 30%) of the bottom side of the object region only has to be within the first area. The same holds true for the second area. The criterion is not limited to this example, and the determination unit 23 may determine that the position of a passenger is within the first or second area, when at least a predetermined percentage of the area of the object region is within the first or second area. The predetermined percentage may be set individually on a part-by-part basis. In this way, whether the position of a passenger is within the first or second area is determined more correctly.

The first period may be, for example, a period corresponding to the cycle of image generation by the camera 2 or a period several times as long as the cycle. The second period may be, for example, several times as long as the first period. By setting each period in this way, entry of a passenger into the exclusion zone 1b is detected early in a short time, when the passenger is within the first area where it is supposed that the passenger has certainly entered the exclusion zone 1b. Even when a passenger is within the second area where it is supposed that the passenger may have entered the exclusion zone 1b, entry of the passenger into the exclusion zone 1b is correctly detected by his/her presence in the second area being detected for the relatively long second period.

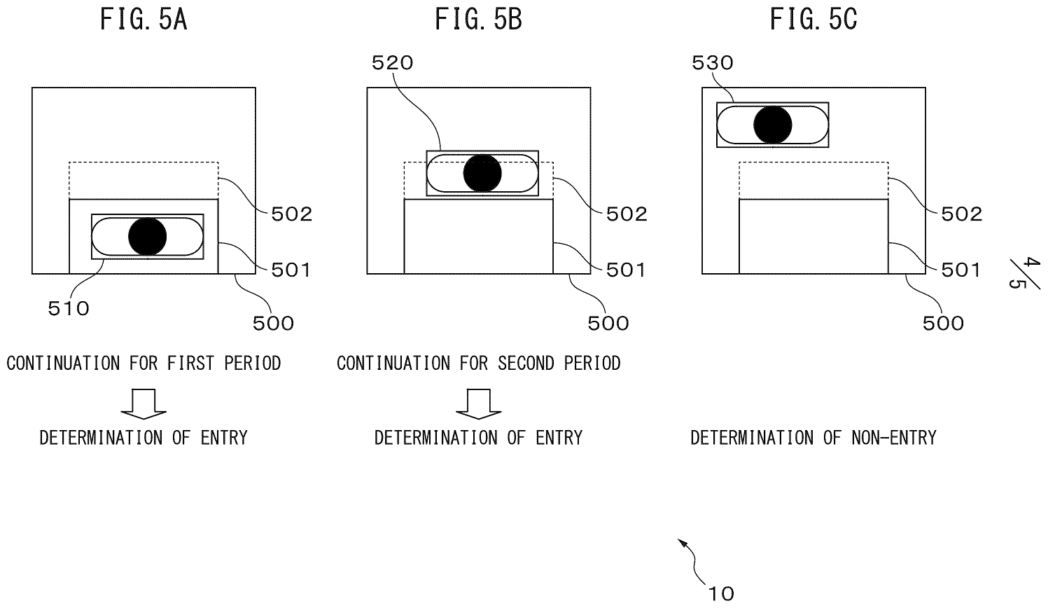

FIGS. 5A to 5C schematically illustrate determination of entry of a passenger into the exclusion zone. In these examples, the entrance 1a is represented near the bottom of images 500 in FIGS. 5A to 5C representing the predetermined region 1c in the interior of the vehicle 1, and an area in each image 500 corresponding to the exclusion zone 1b close to the entrance 1a is set as a first area 501. In addition, a second area 502 is set so as to adjoin the first area 501 on the upper side of the first area 501. The second area may also be set in areas adjoining the sides of the first area.

In the example illustrated in FIG. 5A, the bottom of an object region 510 representing a passenger is within the first area 501. For this reason, when the state has continued for a first period, the passenger represented in the object region 510 is determined to have entered the exclusion zone 1b.

In the example illustrated in FIG. 5B, the bottom of an object region 520 representing a passenger is not within the first area 501 but is within the second area 502. Thus, when the state has continued for a second period, the passenger represented in the object region 520 is determined to have entered the exclusion zone 1b.

In the example illustrated in FIG. 5C, the bottom of an object region 530 representing a passenger is not within the first area 501 or the second area 502. For this reason, the passenger represented in the object region 530 is determined not to have entered the exclusion zone 1b, as long as the state continues.

When a passenger is determined to have entered the exclusion zone 1b, the determination unit 23 notifies the determination to the alert processing unit 24.

When notified by the determination unit 23 that a passenger has entered the exclusion zone 1b, the alert processing unit 24 outputs an alert signal indicating a warning of entry of a passenger into the exclusion zone 1b to the alert device 3 via the communication interface 11. In this way, the passenger's attention is drawn to entry into the exclusion zone 1b via the alert device 3. Alternatively, the alert processing unit 24 may output an entry warning signal indicating entry of a passenger into the exclusion zone 1b to an electronic control unit (ECU) of the vehicle 1 via the communication interface 11. The ECU may stop opening and closing the door of the entrance 1a while the entry warning signal is received. The alert processing unit 24 may output an alert signal to the alert device 3 or an entry warning signal to the ECU only in a period from when a prediction signal predicting that the door of the entrance 1a will be opened or closed is received by the monitoring device 4 from the ECU of the vehicle 1 until an opening/closing signal indicating that the door has actually been opened or closed is received by the monitoring device from the ECU. This prevents an unnecessary warning at entry of a passenger into the exclusion zone 1b when the entrance 1a is not opened or closed, reducing the passenger's annoyance.

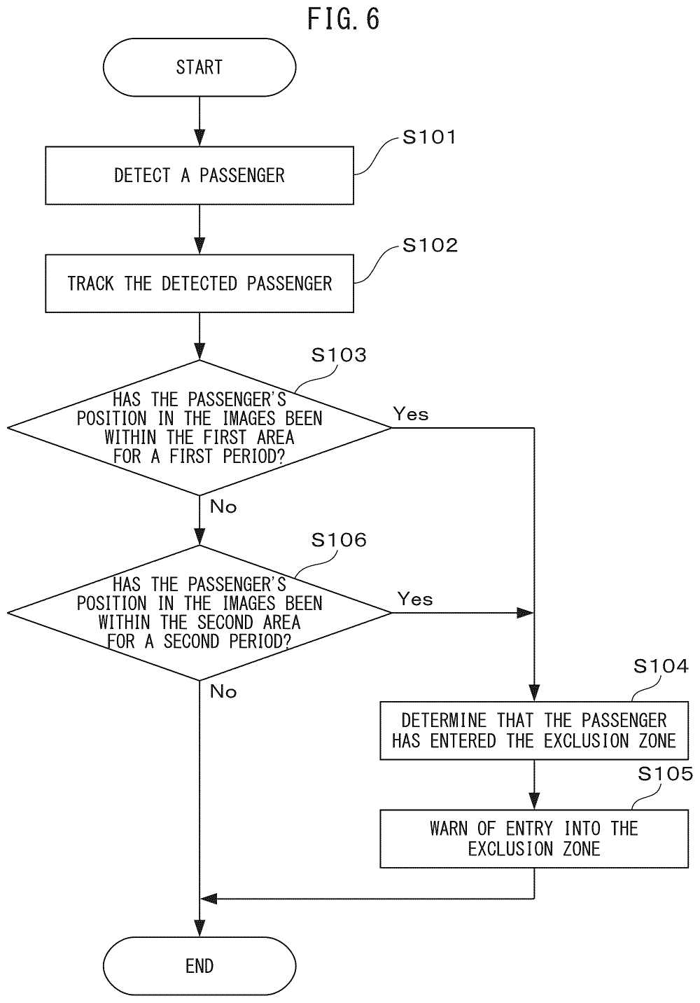

FIG. 6 is an operation flowchart of the monitoring process. The processor 13 executes the monitoring process in accordance with the operation flowchart described below.

The detection unit 21 detects a passenger from images generated by the camera 2 (step S101). The tracking unit 22 tracks the detected passenger (step S102).

For each detected passenger, the determination unit 23 determines whether the passenger's position in the images has been within the first area for a first period (step S103). When the position of a passenger has been within the first area for the first period (Yes in step S103), the determination unit 23 determines that the passenger has entered the exclusion zone 1b (step S104). The alert processing unit 24 then warns the passenger of entry into the exclusion zone 1b via the alert device 3 (step S105).

When no passenger is within the first area or has been within the first area for the first period (No in step S103), the determination unit 23 determines whether the position of each detected passenger in the images has been within the second area for a second period (step S106). When the position of a passenger has been within the second area for the second period (Yes in step S106), the processor 13 executes processing of steps S104 and S105.

After step S105 or when the passenger's position in the images is not within the second area or has not been within the second area for the second period in step S106 (No in step S106), the processor 13 terminates the monitoring process.

As has been described above, for each person detected from a plurality of time-series images and being tracked, the monitoring device determines whether the position of the person in the images is within a first area in the images corresponding to the exclusion zone and whether the position of the person in the images is within a second area in the images adjacent to the first area. The monitoring device determines that the person has entered the exclusion zone, when duration during which the position of the person in the images is within the first area reaches a first period or when duration during which the position of the person in the images is within the second area reaches a second period. In this way, the monitoring device can detect entry of a person into the exclusion zone correctly.

Depending on the mounted position and orientation of the camera, the positions of individual parts of a person in the images may differ when the person is within the exclusion zone. For example, when the camera is mounted so as to take pictures of the exclusion zone from obliquely above, the positions of a person's feet and head in the images may differ greatly even if the person is standing in the exclusion zone. Thus, according to a modified example, the first and second areas may be set individually depending on a person's parts. In this case, for each part, the first area in the images corresponding to the exclusion zone is set as an area representing the part for the case where a person is in the exclusion zone, depending on a supposed height of the part. The second area of each part is set adjacent to the first area so as to include the position of the part in the images for the case where the part may have entered the exclusion zone. For each person's part, the determination unit 23 determines whether an object region including the part is within the first or second area corresponding to the part. According to this modified example, the monitoring device can detect a person who has entered the exclusion zone more correctly.

The computer program causing a computer to execute the process of the processor 13 of the monitoring device 4 according to the above-described embodiment or modified example may be distributed, for example, in a form recorded on a storage medium such as an optical medium or a magnetic medium.

As described above, those skilled in the art may make various modifications according to embodiments within the scope of the present disclosure.

What is claimed is:

1. A monitoring device comprising:
a processor configured to:
detect a person from each of a plurality of time-series images generated by a camera configured to take pictures of a predetermined region including an exclusion zone,
track the detected person in one or more images representing the person among the plurality of images,
determine whether a position of the detected person in the images has been within a first area in the images corresponding to the exclusion zone for a first period and whether the position of the detected person in the images has been within a second area in the images adjacent to the first area for a second period longer than the first period, based on a result of tracking, and
determine that the detected person has entered the exclusion zone, when the position of the detected person in the images has been within the first area for the first period or within the second area for the second period.

2. The monitoring device according to claim 1, wherein the processor is further configured to detect at least two different parts of the person from each of the plurality of images,
track each of the detected at least two parts, and
determine that the person has entered the exclusion zone, when the position of one of the detected at least two parts in the images has been within the first area for the first period or within the second area for the second period.

3. The monitoring device according to claim 2, wherein the first area and the second area are set for each of the at least two parts.

4. A monitoring method comprising:
detecting a person from each of a plurality of time-series images generated by a camera configured to take pictures of a predetermined region including an exclusion zone;
tracking the detected person in one or more images representing the person among the plurality of images;
determining whether a position of the detected person in the images has been within a first area in the images corresponding to the exclusion zone for a first period and whether the position of the detected person in the images has been within a second area in the images adjacent to the first area for a second period longer than the first period, based on a result of tracking; and
determining that the detected person has entered the exclusion zone, when the position of the detected person in the images has been within the first area for the first period or within the second area for the second period.

5. A non-transitory recording medium that stores a computer program for monitoring, the computer program causing a computer to execute a process comprising:
detecting a person from each of a plurality of time-series images generated by a camera configured to take pictures of a predetermined region including an exclusion zone;
tracking the detected person in one or more images representing the person among the plurality of images;
determining whether a position of the detected person in the images has been within a first area in the images corresponding to the exclusion zone for a first period and whether the position of the detected person in the images has been within a second area in the images adjacent to the first area for a second period longer than the first period, based on a result of tracking; and
determining that the detected person has entered the exclusion zone, when the position of the detected person in the images has been within the first area for the first period or within the second area for the second period.
